(19) United States
(12) Patent Application Publication
(10) Pub. No.: US 2026/0058848 A1
(43) Pub. Date: Feb. 26, 2026

(54) DECISION FEEDBACK EQUALIZER WITH RESET

(71) Applicant: Micron Technology, Inc., Boise, ID (US)

(72) Inventor: Jinha Hwang, Boise, ID (US)

(21) Appl. No.: 19/222,769

(22) Filed: May 29, 2025

Related U.S. Application Data
(60) Provisional application No. 63/685,440, filed on Aug. 21, 2024.

(51) Int. Cl. H04L 25/03

(52) U.S. Cl. CPC H04L 25/03057

(57) ABSTRACT

A device is provided that includes decision feedback equalizer (DFE) reset circuitry. The DFE reset circuitry includes synchronous circuitry and the DFE reset circuitry is configured to receive a DFE reset signal to initiate a reset operation of a DFE, generate a first control signal based upon the DFE reset signal, and transmit the first control signal to alter a data signal generated in a summer circuit of the DFE to affect the reset operation of the DFE.

### CROSS REFERENCE TO RELATED APPLICATIONS

This application is a Non-Provisional Application claiming priority to U.S. Provisional Patent Application No. 63/685,440, entitled “DECISION FEEDBACK EQUALIZER WITH RESET”, filed Aug. 21, 2024, which is herein incorporated by reference.

### BACKGROUND

### Field of the Present Disclosure

Embodiments of the present disclosure relate generally to the field of input buffers and Decision Feedback Equalizers (DFEs) for memory devices. More specifically, embodiments of the present disclosure relate to improving reset capabilities of the DFE.

### Description of Related Art

The operational rate of memory devices, including the data rate of a memory device, has been increasing over time. As a side effect of the increase in speed of a memory device, data errors due to distortion may increase. For example, inter-symbol interference between transmitted data whereby previously received data influences the currently received data may occur (e.g., previously received data affects and interferes with subsequently received data). One manner to correct for this interference is through the use of a decision feedback equalizer (DFE) circuit, which may be programmed to offset (i.e., undo or mitigate) the effect of the channel on the transmitted data.

To insure the proper functioning of the DFE circuit, reliable input signals should be available. Additionally, as rates of operation increase (e.g., as data speeds increase), the DFE should be able to correct for inter-symbol interference at a rate that at least matches the rate of incoming data.

Embodiments of the present disclosure may be directed to one or more of the problems set forth above.

### BRIEF DESCRIPTION OF DRAWINGS

Various aspects of this disclosure may better be understood upon reading the following detailed description and upon reference to the drawings in which:

FIG. 1 is a simplified block diagram illustrating certain features of a memory device, according to an embodiment of the present disclosure;

FIG. 2 is a block diagram illustrating a data transceiver of the I/O interface of FIG. 1, according to an embodiment of the present disclosure;

FIG. 3 illustrates a block diagram of an embodiment of the data transceiver of FIG. 2, according to an embodiment of the present disclosure;

FIG. 4 illustrates a high level diagram of a Decision Feedback Equalizer of the data transceiver of FIG. 2, according to an embodiment of the present disclosure;

FIG. 5 illustrates a block diagram of a first embodiment of the DFE of FIG. 4, according to an embodiment of the present disclosure;

FIG. 6 illustrates a block diagram of a second embodiment the DFE of FIG. 4, according to an embodiment of the present disclosure;

FIG. 7 illustrates a first embodiment of circuitry utilized in conjunction with the second embodiment of the DFE of FIG. 6, according to an embodiment of the present disclosure;

FIG. 8 illustrates a first embodiment of reset circuitry utilized in conjunction with the first embodiment of circuitry of FIG. 7, according to an embodiment of the present disclosure;

FIG. 9 illustrates a first embodiment of control circuitry utilized in conjunction with the first embodiment of circuitry of FIG. 7, according to an embodiment of the present disclosure;

FIG. 10 illustrates a second embodiment of reset circuitry utilized in conjunction with the second embodiment of the DFE of FIG. 6, according to an embodiment of the present disclosure;

FIG. 11 illustrates a second embodiment of control circuitry utilized in conjunction with the second embodiment of reset circuitry of FIG. 10, according to an embodiment of the present disclosure; and

FIG. 12 illustrates a second embodiment of circuitry utilized in conjunction with the second embodiment of reset circuitry of FIG. 10 and the second embodiment of control circuitry of FIG. 11, according to an embodiment of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Using a decision feedback equalizer (DFE) of a memory device to perform distortion correction techniques may be valuable, for example, to correctly compensate for distortions in the received data of the memory device. This insures that accurate values are being stored in the memory of the memory device. The DFE may use previous bit data to create corrective values to compensate for distortion resulting from previously received data bit(s). For example, the most recent previous bit may have more of a distortion effect on the current bit than a bit transmitted several data points before, causing the corrective values to be different between the two bits. With these levels to correct for, the DFE may operate to correct the distortion of the transmitted bit.

Resetting of the DFE can be useful between memory operations. However, as operating speeds continue to increase, there may be insufficient time for a DFE reset operation to be completed prior to another memory operation being undertaken. Accordingly, different architectures that reduce DFE reset operation time are contemplated and are described herein. For example, one embodiment of a DFE that can be reset includes one or more double tail latches that are utilized in conjunction with a reset operation of the DFE without use of any reset latches disposed in the one or more double tail latches. Additionally, the reset operation can be performed without the circuitry of the double tail latches directly receiving a reset signal (e.g., an RstHi signal and/or a RstHiF signal).

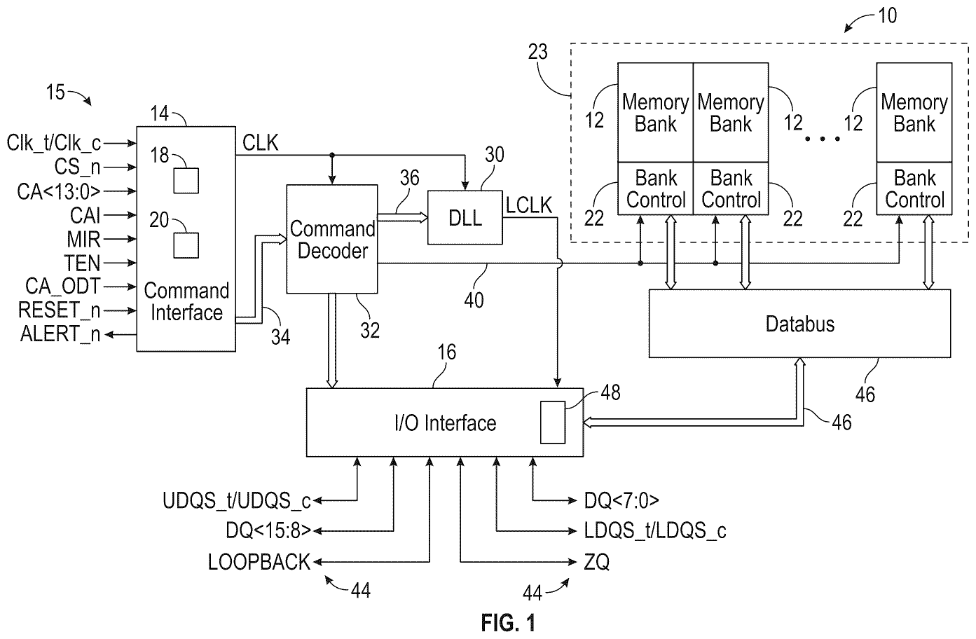

Turning now to the figures, FIG. 1 is a simplified block diagram illustrating certain features of a memory device 10. Specifically, the block diagram of FIG. 1 is a functional block diagram illustrating certain functionality of the memory device 10. In accordance with one embodiment, the memory device 10 may be a double data rate type five synchronous dynamic random access memory (DDR5 SDRAM or DDR5) device. Various features of DDR5 SDRAM allow for reduced power consumption, more bandwidth and more storage capacity compared to prior generations of DDR SDRAM. However, more generally, the memory device 10 may be a random access memory (RAM) device, a dynamic RAM (DRAM) device, a static RAM (SRAM) device (including a double data rate SRAM device), flash memory, and/or a phase change memory (PCM) device and/or other chalcogenide-based memory, such as self-selecting memories (SSM), a double data rate type four synchronous dynamic random access memory (DDR4 SDRAM) device, a low power double data rate type four synchronous dynamic random access memory (LPDDR4 SDRAM), a low power double data rate type five synchronous dynamic random access memory (LPDDR5 SDRAM) device, a data rate type six synchronous dynamic random access memory (DDR6 SDRAM or DDR6), or another type of device.

The memory device 10, may include a number of memory banks 12. The memory banks 12 may be DDR5 SDRAM memory banks, for instance. The memory banks 12 may be provided on one or more chips (e.g., SDRAM chips) that are arranged on dual inline memory modules (DIMMS). Each DIMM may include a number of SDRAM memory chips (e.g., x8 or x16 memory chips), as will be appreciated. Each SDRAM memory chip may include one or more memory banks 12. The memory device 10 represents a portion of a single memory chip (e.g., SDRAM chip) having a number of memory banks 12. For DDR5, the memory banks 12 may be further arranged to form bank groups. For instance, for an 8 gigabit (Gb) DDR5 SDRAM, the memory chip may include 16 memory banks 12, arranged into 8 bank groups, each bank group including 2 memory banks. For a 16 GB DDR5 SDRAM, the memory chip may include 32 memory banks 12, arranged into 8 bank groups, each bank group including 4 memory banks, for instance. Various other configurations, organization and sizes of the memory banks 12 on the memory device 10 may be utilized depending on the application and design of the overall system.

The memory device 10 may include a command interface 14 and an input/output (I/O) interface 16 configured to exchange (e.g., receive and transmit) signals with external devices. The command interface 14 is configured to provide a number of signals (e.g., signals 15) from an external device (not shown), such as a processor or controller (e.g., present in a host device coupled to the memory device 10). The processor or controller may provide various signals 15 to the memory device 10 to facilitate the transmission and receipt of data to be written to or read from the memory device 10.

As will be appreciated, the command interface 14 may include a number of circuits, such as a clock input circuit 18 and a command address input circuit 20, for instance, to ensure proper handling of the signals 15. The command interface 14 may receive one or more clock signals from an external device. Generally, double data rate (DDR) memory utilizes a differential pair of system clock signals, referred to herein as the true clock signal (Clk_t) and the complementary clock signal (Clk_c). The positive clock edge for DDR refers to the point where the rising true clock signal Clk_t crosses the falling complementary clock signal Clk_c, while the negative clock edge indicates the transition of the falling true clock signal Clk_t and the rising of the complementary clock signal Clk_c. Commands (e.g., read command, write command, etc.) are typically entered on the positive edges of the clock signal and data is transmitted or received on both the positive and negative clock edges.

The clock input circuit 18 receives the true clock signal (Clk_t) and the complementary clock signal (Clk_c) and generates an internal clock signal CLK. The internal clock signal CLK is supplied to an internal clock generator 30, such as a delay locked loop (DLL) circuit. The internal clock generator 30 generates a phase controlled internal clock signal LCLK based on the received internal clock signal CLK. The phase controlled internal clock signal LCLK is supplied to the input/output (I/O) interface 16, for instance, and is used as a timing signal for determining an output timing of read data.

The internal clock signal CLK may also be provided to various other components within the memory device 10 and may be used to generate various additional internal clock signals. For instance, the internal clock signal CLK may be provided to a command decoder 32. The command decoder 32 may receive command signals from the command bus 34 and may decode the command signals to provide various internal commands. For example, the command decoder 32 may provide command signals to the internal clock generator 30 over the bus 36 to coordinate generation of the phase controlled internal clock signal LCLK. The phase controlled internal clock signal LCLK may be used to clock data through the I/O interface 16, for instance.

Further, the command decoder 32 may decode commands, such as read commands, write commands, mode-register set commands, activate commands, etc., and provide access to a particular memory bank 12 corresponding to the command, via the bus path 40. As will be appreciated, the memory device 10 may include various other decoders, such as row decoders and column decoders, to facilitate access to the memory banks 12. In one embodiment, each memory bank 12 includes a bank control block 22 which provides decoding (e.g., row decoder and column decoder), as well as other features, such as timing control and data control, to facilitate the execution of commands to and from the memory banks 12. Collectively, the memory banks 12 and the bank control blocks 22 may be referred to as a memory array 23.

The memory device 10 executes operations, such as read commands and write commands, based on the command/address signals received from an external device, such as a processor. In one embodiment, the command/address bus may be a 14-bit bus to accommodate the command/address signals (CA<13:0>). The command/address signals are clocked to the command interface 14 using the clock signals (Clk_t and Clk_c). The command interface may include a command address input circuit 20 which is configured to receive and transmit the commands to provide access to the memory banks 12, through the command decoder 32, for instance. In addition, the command interface 14 may receive a chip select signal (CS_n). The CS_n signal enables the memory device 10 to process commands on the incoming CA<13:0> bus. Access to specific banks 12 within the memory device 10 is encoded on the CA<13:0> bus with the commands.

In addition, the command interface 14 may be configured to receive a number of other command signals. For instance, a command/address on die termination (CA_ODT) signal may be provided to facilitate proper impedance matching within the memory device 10. A reset command (RESET_n) may be used to reset the command interface 14, status registers, state machines and the like, during power-up for instance. The command interface 14 may also receive a command/address invert (CAI) signal which may be provided to invert the state of command/address signals CA<13:0> on the command/address bus, for instance, depending on the command/address routing for the particular memory device 10. A mirror (MIR) signal may also be provided to facilitate a mirror function. The MIR signal may be used to multiplex signals so that they can be swapped for enabling certain routing of signals to the memory device 10, based on the configuration of multiple memory devices in a particular application. Various signals to facilitate testing of the memory device 10, such as the test enable (TEN) signal, may be provided as well. For instance, the TEN signal may be used to place the memory device 10 into a test mode for connectivity testing.

The command interface 14 may also be used to provide an alert signal (ALERT_n) to the system processor or controller for certain errors that may be detected. For instance, an alert signal (ALERT_n) may be transmitted from the memory device 10 if a cyclic redundancy check (CRC) error is detected. Other alert signals may also be generated. Further, the bus and pin for transmitting the alert signal (ALERT_n) from the memory device 10 may be used as an input pin during certain operations, such as the connectivity test mode executed using the TEN signal, as described above.

Data may be sent to and from the memory device 10, utilizing the command and clocking signals discussed above, by transmitting and receiving data signals 44 through the I/O interface 16. More specifically, the data may be sent to or retrieved from the memory banks 12 over the data bus 46, which includes a plurality of bi-directional data buses. Data I/O signals, generally referred to as DQ signals, are generally transmitted and received in one or more bi-directional data busses. For certain memory devices, such as a DDR5 SDRAM memory device, the I/O signals may be divided into upper and lower bytes. For instance, for an x16 memory device, the I/O signals may be divided into upper and lower I/O signals (e.g., DQ<15:8> and DQ<7:0>) corresponding to upper and lower bytes of the data signals, for instance.

To allow for higher data rates within the memory device 10, certain memory devices, such as DDR memory devices may utilize data strobe signals, generally referred to as DQS signals. The DQS signals are driven by the external processor or controller sending the data (e.g., for a write command) or by the memory device 10 (e.g., for a read command). For read commands, the DQS signals are effectively additional data output (DQ) signals with a predetermined pattern. For write commands, the DQS signals are used as clock signals to capture the corresponding input data. As with the clock signals (Clk_t and Clk_c), the data strobe (DQS) signals may be provided as a differential pair of data strobe signals (DQS_t and DQS_c) to provide differential pair signaling during reads and writes. For certain memory devices, such as a DDR5 SDRAM memory device, the differential pairs of DQS signals may be divided into upper and lower data strobe signals (e.g., UDQS_t and UDQS_c; LDQS_t and LDQS_c) corresponding to upper and lower bytes of data sent to and from the memory device 10, for instance.

An impedance (ZQ) calibration signal may also be provided to the memory device 10 through the I/O interface 16. The ZQ calibration signal may be provided to a reference pin and used to tune output drivers and on die termination values (ODT) by adjusting pull-up and pull-down resistors of the memory device 10 across changes in process, voltage and temperature (PVT) values. Because PVT characteristics may impact the ZQ resistor values, the ZQ calibration signal may be provided to the ZQ reference pin to be used to adjust the resistance to calibrate the input impedance to known values. As will be appreciated, a precision resistor is generally coupled between the ZQ pin on the memory device 10 and GND/VSS external to the memory device 10. This resistor acts as a reference for adjusting internal ODT and drive strength of the I/O pins.

In addition, a loopback signal (LOOPBACK) may be provided to the memory device 10 through the I/O interface 16. The loopback signal may be used during a test or debugging phase to set the memory device 10 into a mode wherein signals are looped back through the memory device 10 through the same pin. For instance, the loopback signal may be used to set the memory device 10 to test the data output of the memory device 10. Loopback may include both a data and a strobe or possibly just a data pin. This is generally intended to be used to monitor the data captured by the memory device 10 at the I/O interface 16.

As will be appreciated, various other components such as power supply circuits (for receiving external VDD and VSS signals), mode registers (to define various modes of programmable operations and configurations), read/write amplifiers (to amplify signals during read/write operations), temperature sensors (for sensing temperatures of the memory device 10), etc., may also be incorporated into a memory system incorporating the memory device 10. Accordingly, it should be understood that the block diagram of FIG. 1 is only provided to highlight certain functional features of the memory device 10 to aid in the subsequent detailed description.

In some embodiments, the memory device 10 may be disposed in (physically integrated into or otherwise connected to) a host device or otherwise coupled to a host device. The host device may include any one of a desktop computer, laptop computer, pager, cellular phone, personal organizer, portable audio player, control circuit, camera, etc. The host device may also be a network node, such as a router, a server, or a client (e.g., one of the previously-described types of computers). The host device may be some other sort of electronic device, such as a copier, a scanner, a printer, a game console, a television, a set-top video distribution or recording system, a cable box, a personal digital media player, a factory automation system, an automotive computer system, or a medical device. (The terms used to describe these various examples of systems, like many of the other terms used herein, may share some referents and, as such, should not be construed narrowly in virtue of the other items listed.)

The host device may, thus, be a processor-based device, which may include a processor, such as a microprocessor, that controls the processing of system functions and requests in the host. Further, any host processor may comprise a plurality of processors that share system control. The host processor may be coupled directly or indirectly to additional system elements of the host, such that the host processor controls the operation of the host by executing instructions that may be stored within the host or external to the host.

As discussed above, data may be written to and read from the memory device 10, for example, by the host whereby the memory device 10 operates as volatile memory, such as Double Data Rate DRAM (e.g., DDR5 SDRAM). The host may, in some embodiments, also include separate non-volatile memory, such as read-only memory (ROM), PC-RAM, silicon-oxide-nitride-oxide-silicon (SONOS) memory, metal-oxide-nitride-oxide-silicon (MONOS) memory, polysilicon floating gate based memory, and/or other types of flash memory of various architectures (e.g., NAND memory, NOR memory, etc.) as well as other types of memory devices (e.g., storage), such as solid state drives (SSD's), MultimediaMediaCards (MMC's), SecureDigital (SD) cards, CompactFlash (CF) cards, or any other suitable device. Further, it should be appreciated that the host may include one or more external interfaces, such as Universal Serial Bus (USB), Peripheral Component Interconnect (PCI), PCI Express (PCI-E), Small Computer System Interface (SCSI), IEEE 1394 (Firewire), or any other suitable interface as well as one or more input devices to allow a user to input data into the host, for example, buttons, switching elements, a keyboard, a light pen, a stylus, a mouse, and/or a voice recognition system, for instance. The host may optionally also include an output device, such as a display coupled to the processor and a network interface device, such as a Network Interface Card (NIC), for interfacing with a network, such as the Internet. As will be appreciated, the host may include many other components, depending on the application of the host.

The host may operate to transfer data to the memory device 10 for storage and may read data from the memory device 10 to perform various operations at the host. Accordingly, to facilitate these data transmissions, in some embodiments, the I/O interface 16 may include a data transceiver 48 that operates to receive and transmit DQ signals to and from the I/O interface 16.

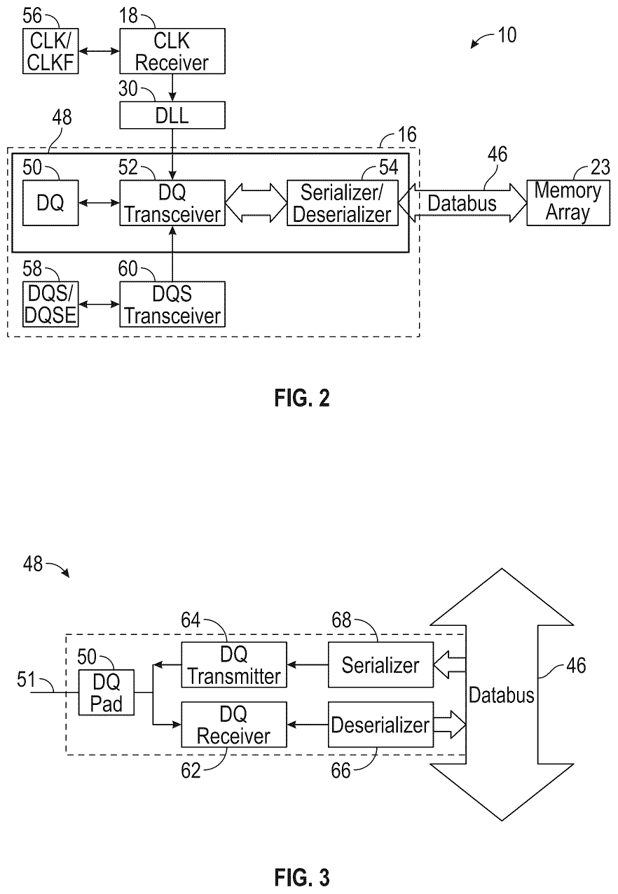

FIG. 2 illustrates the I/O interface 16 of the memory device 10 generally and, more specifically, the data transceiver 48. As illustrated, the data transceiver 48 of the I/O interface 16 may include a DQ connector 50, a DQ transceiver 52, and a serializer/deserializer 54. It should be noted that in some embodiments, multiple data transceivers 48 may be utilized whereby each single data transceiver 48 may be utilized in connection with a respective one of each of upper and lower I/O signals (e.g., DQ<15:8> and DQ<7:0>) corresponding to upper and lower bytes of the data signals, for instance. Thus, the I/O interface 16 may include a plurality of data transceivers 48, each corresponding to one or more I/O signals (e.g., inclusive of a respective DQ connector 50, DQ transceiver 52, and serializer/deserializer 54).

The DQ connector 50 may be, for example a pin, pad, combination thereof, or another type of interface that operates to receive DQ signals, for example, for transmission of data to the memory array 23 as part of a data write operation. Additionally, the DQ connector 50 may operate to transmit DQ signals from the memory device 10, for example, to transmit data from the memory array 23 as part of a data read operation. To facilitate these data reads/writes, a DQ transceiver 52 is present in data transceiver 48. In some embodiments, for example, the DQ transceiver 52 may receive a clock signal generated by the internal clock generator 30 as a timing signal for determining an output timing of a data read operation from the memory array 23. The clock signal transmitted by the internal clock generator 30 may be based upon one or more clocking signals received by the memory device 10 at clock connector 56 (e.g., a pin, pad, the combination thereof, etc.) and routed to the internal clock generator 30 via the clock input circuit 18. Thus, the DQ transceiver 52 may receive a clock signal generated by the internal clock generator 30 as a timing signal for determining an output timing of a data read operation from the memory array 23.

The DQ transceiver 52 of FIG. 2 may also, for example, receive one or more DQS signals to operate in a strobe data mode as part of a data write operation. The signals may be received at a DQS connector 58 (e.g., a pin, pad, the combination thereof, etc.) and routed to the DQ transceiver 52 via a DQS transceiver 60 that operates to control a data strobe mode via selective transmission of the DQS signals to the DQ transceiver 52. Thus, the DQ transceiver 52 may receive DQS signals to control a data write operation from the memory array 23.

As noted above, the data transceiver 48 may operate in modes to facilitate the transfers of the data to and from the memory device 10 (e.g., to and from the memory array 23). For example, to allow for higher data rates within the memory device 10, a data strobe mode in which DQS signals are utilized, may occur. The DQS signals may be driven by an external processor or controller sending the data (e.g., for a write command) as received by the DQS connector 58 (e.g., a pin, pad, the combination thereof, etc.). In some embodiments, the DQS signals are used as clock signals to capture the corresponding input data.

In addition, as illustrated in FIG. 2, the data transceiver 48 also includes a serializer/deserializer 54 that operates to translate serial data bits (e.g., a serial bit stream) into parallel data bits (e.g., a parallel bit stream) for transmission along data bus 46 during data write operations of the memory device 10. Likewise, the serializer/deserializer 54 operates to translate parallel data bits (e.g., a parallel bit stream) into serial data bits (e.g., a serial bit stream) during read operations of the memory device 10. In this manner, the serializer/deserializer 54 operates to translate data received from, for example, a host device having a serial format into a parallel format suitable for storage in the memory array 23. Likewise, the serializer/deserializer 54 operates to translate data received from, for example, the memory array 23 having a parallel format into a serial format suitable for transmission to a host device.

FIG. 3 illustrates the data transceiver 48 as including the DQ connector 50 coupled to data transfer bus 51, a DQ receiver 62, a DQ transmitter 64 (which in combination with the DQ receiver 62 forms the DQ transceiver 52), a deserializer 66, and a serializer 68 (which in combination with the deserializer 66 forms the serializer/deserializer 54). In operation, the host (e.g., a host processor or other memory device described above) may operate to transmit data in a serial form across data transfer bus 51 to the data transceiver 48 as part of a data write operation to the memory device 10. This data is received at the DQ connector 50 and transmitted to the DQ receiver 62. The DQ receiver 62, for example, may perform one or more operations on the data (e.g., amplification, driving of the data signals, etc.) and/or may operate as a latch for the data until reception of a respective DQS signal that operates to coordinate (e.g., control) the transmission of the data to the deserializer 66. As part of a data write operation, the deserializer 66 may operate to convert (e.g., translate) data from a format (e.g., a serial form) in which it is transmitted along data transfer bus 51 into a format (e.g., a parallel form) used for transmission of the data to the memory array 23 for storage therein.

Likewise, during a read operation (e.g., reading data from the memory array 23 and transmitting the read data to the host via the data transfer bus 51), the serializer 68 may receive data read from the memory array 23 in one format (e.g., a parallel form) used by the memory array 23 and may convert (e.g., translate) the received data into a second format (e.g., a serial form) so that the data may be compatible with one or more of the data transfer bus 51 and/or the host. The converted data may be transmitted from the serializer 68 to the DQ transmitter 64, whereby one or more operations on the data (e.g., de-amplification, driving of the data signals, etc.) may occur. Additionally, the DQ transmitter 64 may operate as a latch for the received data until reception of a respective clock signal, for example, from the internal clock generator 30, that operates to coordinate (e.g., control) the transmission of the data to the DQ connector 50 for transmission along the data transfer bus 51 to one or more components of the host.

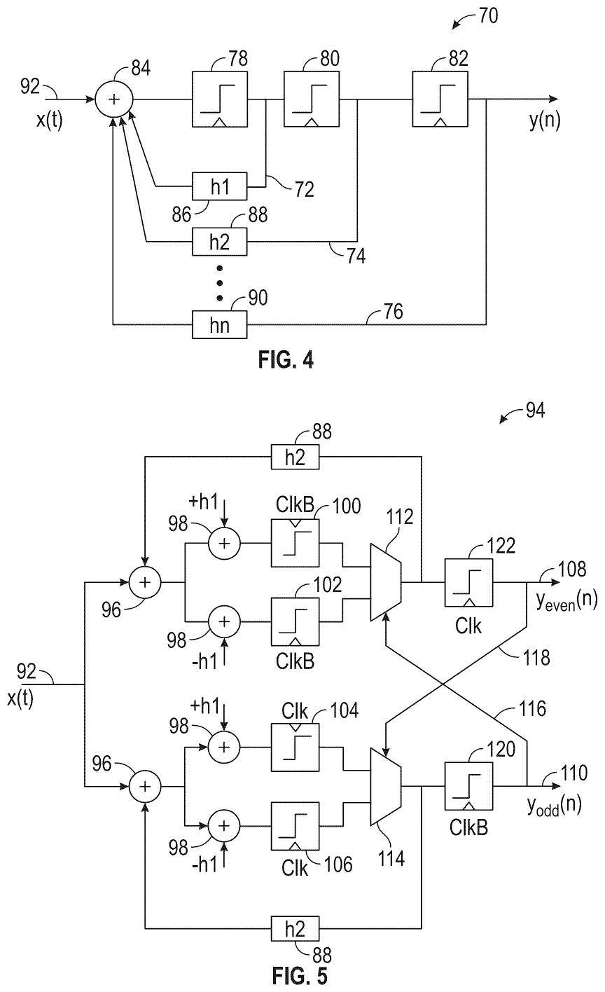

In some embodiments, the data received at the DQ connector 50 may be distorted. For example, data received at the DQ connector 50 may be affected by inter-symbol interference (ISI) in which previously received data interferes with subsequently received data. For example, due to increased data volume being transmitted across the data transfer bus 51 to the DQ connector 50, the data received at the DQ connector 50 may be distorted relative to the data transmitted by the host. One technique to mitigate (e.g., offset or cancel) this distortion and to effectively reverse the effects of ISI is to apply an equalization operation to the data. FIG. 4 illustrates an embodiment of an equalizer that may be used in this equalization operation.

FIG. 4 illustrates one embodiment an equalizer, in particular, a decision feedback equalizer (DFE) 70. As illustrated, the DFE 70 represents an N-tap DFE 70, where “N” is a positive integer value. For example, a 1-tap DFE, a 2-tap DFE, a 3-tap DFE, a 4 tap DFE or another N-tap DFE may be implemented as the DFE 70. The DFE 70 may be disposed separate from or internal to the deserializer 66 or the DQ receiver 62 of FIG. 3. In operation, a binary output (e.g., from a latch or decision-making slicer) is captured in one or more data latches or data registers. In the present embodiment, these data latches or data registers may be disposed in the deserializer 66 and the values stored therein may be latched or transmitted along paths 72, 74, and 76.

When a data bit is received at the DQ receiver 62, it may be identified as being transmitted from the host as bit “x(t)” and may be received at a time to as distorted bit x (e.g., bit x having been distorted by ISI). The most recent bit received prior to distorted bit x being received at the DQ receiver 62, e.g., received at time of t-1 that immediately precedes time of to, may be identified as x-1 and is illustrated as being transmitted from a data latch 78 along path 72. The second most recent bit received prior to distorted bit x being received at the DQ receiver 62, e.g., received at time of t-2 that immediately precedes time of t-1, may be identified as x-2 and is illustrated as being transmitted from data latch 80 along path 74. This process can continue with additional latches until latch 82, which corresponds to the Nth latch and transmits the least recent bit (x-N) received prior to distorted bit x being received at the DQ receiver 62, e.g., received at time of t-N that immediately precedes time of t-N-1, which is transmitted along path 76. Bits x-1, x-2, . . . x-N may be considered the group of bits that interfere with received distorted bit x (e.g., bits x-1, x-2, . . . x-N cause ISI to host transmitted bit x) and the DFE 70 may operate to offset the distortion caused by the group of bits x-1, x-2, . . . x-N on host transmitted bit x.

Thus, the values latched or transmitted along paths 72, 74, and 76, may correspond, respectively, to the most recent previous data values (e.g., preceding bits x-1, x-2, . . . x-N) transmitted from the DQ receiver 62 to be stored in memory array 23. These previously transmitted bits are fed back along paths 72, 74, and 76 and are used in generation of weighted tap 86 (e.g., h1), weighted tap 88 (e.g., h2), and weighted tap 90 (e.g., hn) represented as being disposed along paths 72, 74, and 76. Weighted tap 86, weighted tap 88, and weighted tap 90 can each correspond to respective adjustments (e.g., voltages) that may be and added to the received input signal (e.g., data received from the DQ connector 50, such as distorted bit x) by means of the summer 84 (e.g., a summing amplifier). In other embodiments, weighted tap 86, weighted tap 88, and weighted tap 90 may be combined with an initial reference value to generate an offset that corresponds to or mitigates the distortion of the received data (e.g., mitigates the distortion of distorted bit x). In some embodiments, taps are weighted to reflect that the most recent previously received data (e.g., bit x-1 and weighted tap 86) may have a stronger influence on the distortion of the received data (e.g., distorted bit x) than bits received at earlier times (e.g., bits x-2 and x-N). The DFE 70 may operate to generate magnitudes and polarities for weighted tap 86, weighted tap 88, and weighted tap 90 due to each previous bit to collectively offset the distortion caused by those previously received bits.

For example, for the present embodiment, each of previously received bits x-1, x-2, x-3, and x-4 (as bit x-N) could have had one of two values (e.g., a binary 0 or 1), which was transmitted to the deserializer 66 for transmission to the memory array 23 and, additionally, latched or saved in a register for subsequent transmission along respective paths 72, 74, 76, and an additional path corresponding to previously received bit x-3. In this example, sixteen (e.g., 24) possible binary combinations (e.g., 0000, 0001, 0010, . . . , 1110, or 1111) for the group of bits x-1, x-2, x-3, and x-4 would be possible. The DFE 70 operates to select and/or generate corresponding tap values for whichever of the aforementioned sixteen combinations are determined to be present (e.g., based on the received values along paths 72, 74, 76, and the additional path corresponding to previously received bit x-3) to be used to adjust either the input value received from the DQ connector 50 (e.g., distorted bit x) or to modify a reference value that is subsequently applied to the input value received from the DQ connector 50 (e.g., distorted bit x) so as to cancel the ISI distortion from the previous bits in the data stream (e.g., the group of bits x-1, x-2, x-3, and x-4).

Use of distortion correction (e.g., a DFE 70) may be beneficial such that data transmitted from the DQ connector 50 is correctly represented in the memory array 23 without distortion. As noted above, distortion correction circuitry (e.g., equalizer) may be included as part of the DQ receiver 62 but may not be required to be physically located there (e.g., it may instead be coupled to the DQ receiver 62). In some embodiments, the distortion correction circuitry may be operated to provide previously transmitted bit data to correct a distorted bit 81 (e.g., bit having been distorted by ISI and/or system distortions) transmitted via a channel 92 (e.g., connection, transmission line, and/or conductive material).

FIG. 5 illustrates a DFE 94 as an embodiment of an equalizer discussed above. DFE 94 represents a half rate DFE receiver where data (from channel 92) is received at both edges of a clock signal at a frequency of half of the data rate transmitted along channel 92. As illustrated, the DFE 94 represents a 2-tap DFE. However, other variations are contemplated, for example, a 1-tap DFE, a 3-tap DFE, a 4-tap DFE or another N-tap DFE may be implemented as the DFE 94. The DFE 94 may be disposed separate from or internal to the deserializer 66 or the DQ receiver 62 of FIG. 3.

The DFE 94 includes a first stage of summers 96 that each receive a second weighted tap (e.g., h2) as a feedback signal. Additionally, the first stage of summers 96 receive the data stream along channel 92 (e.g., bits x, x-1, x-2, etc.). Additionally, the DFE 94 is a speculative equalizer. Accordingly, a first weighted tap (e.g., h1) is transmitted as an input to a second stage of summers 98. As illustrated, the first weighted tap is implemented via speculation, so a positive weighted tap value (e.g., +h1) and a negative weighted tap value (e.g., −h1) are provided to the second stage of summers 98.

The DFE 94 further includes latch 100, latch 102, latch 104, and latch 106 (e.g., data slicers). These latches 100, 102, 104, and 106 are controlled by a clock signal CLK. CLK may be a half-rate clock signal, whereby latches 100 and 102 sample data on a rising edge of CLK to generate even data bits, which are output from the DFE 94 along path 108. Likewise, latches 104 and 106 sample data on a falling edge of CLK to generate odd data bits, which are output from the DFE 94 along path 110. The sampled data from latch 100 and latch 102 is transmitted to a selection circuit 112 while the sampled data from latch 104 and latch 106 is transmitted to a selection circuit 114. Selection circuit 112 and selection circuit 114 can be 2-to-1 multiplexers.

Selection circuit 112, as illustrated, is controlled by a feedback signal transmitted along path 116 and selection circuit 114 is controlled by a feedback signal transmitted along path 118. In operation, the feedback signal along path 116 operates to select the correct weighed tap value (e.g., +h1 or −h1) to be applied by selecting the respective input to the selection circuit 112 that corresponds to that correct weighted tap value as the signal output from the selection circuit 112. Similarly, the feedback signal along path 118 operates to select the correct weighed tap value (e.g., +h1 or −h1) to be applied by selecting the respective input to the selection circuit 112 that corresponds to that correct weighted tap value as the signal output from the selection circuit 114. Furthermore, as illustrated, the feedback signal along path 116 provides the selection signal to an even bit portion of the DFE 94 (i.e., the upper illustrated portion of the DFE 94), since any previous bit was decided by the odd portion of the DFE 94, inclusive of latch 120) and the feedback signal along path 118 provides the selection signal to an odd bit portion of the DFE 94 (i.e., the lower illustrated portion of the DFE 94), since any previous bit was decided by the even portion of the DFE 94 inclusive of latch 122.

In operation, the tap signal path of Tap1 (i.e., providing h1 to the second stage of summers 98) is t_{clk-to-Q}+tu, where t_{clk-to-Q} is the clock-to-Q delay of the respective latches 100, 102, 104, or 106 for a given (e.g., selected) path and tu is the propagation delay of the respective selection circuit 112, 114 for the given (e.g., selected) path. However, the tap signal path of Tap2 (i.e., providing h2 to the first stage of summers 96) is greater than the tap signal path of Tap1. The tap signal path of Tap2 is t_{clk-to-Q}+tu+ts, where t_{clk-to-Q} is the clock-to-Q delay of the respective latches 100, 102, 104, or 106 for a given (e.g., selected) path, tu is the propagation delay of the respective selection circuit 112, 114 for the given (e.g., selected) path, and ts is the settling time attributable to the first stage of summers 96.

As operating speeds increase, the propagation delays described above, particularly with respect to, for example, tap signal path of Tap1 and Tap2, can affect the operation of the DFE 94. This can be due to the propagation delay (e.g., tu) of the respective selection circuit 112, 114 for the given (e.g., selected) path. Indeed, as operating speeds increase, the tap signal path of Tap 1 (i.e., providing h1 to the second stage of summers 98) or Tap2 (i.e., providing h2 to the first stage of summers 96), for example, can arrive subsequent to the data being provided from channel 92 due primarily to the propagation delay (e.g., tu) of the respective selection circuit 112, 114 for the given (e.g., selected) path. Therefore, the weighting value associated with one or both of h1 and h2 will not be correctly applied to the data (i.e., bit) being transmitted to the first stage of summers 96 and/or the second stage of summers 98.

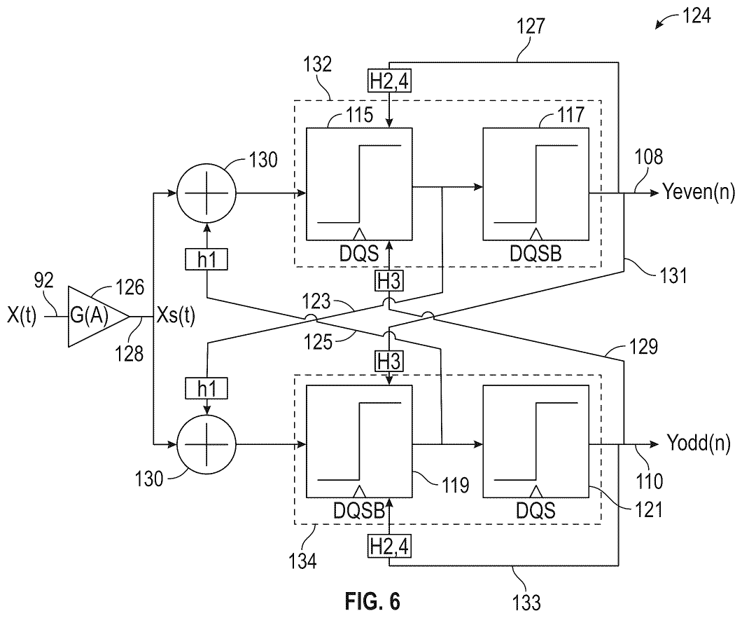

FIG. 6 illustrates DFE 124 as an embodiment of an equalizer discussed above that can overcome the delay issues associated with the propagation delay (e.g., tu) of the respective selection circuit 112, 114 for the given (e.g., selected) path in DFE 94. DFE 124 represents a half rate unroll (no mux) DFE receiver where data (from channel 92) is received at both edges of a clock signal at a frequency of half of the data rate transmitted along channel 92. However, there is no unroll MUX delay (i.e., tu propagation delay) such as that associated with DFE 94 of FIG. 5. As illustrated, the DFE 124 represents a 4-tap DFE. However, other variations are contemplated, for example, a 1-tap DFE, a 2-tap DFE, a 3-tap DFE or another N-tap DFE may be implemented as the DFE 124. The DFE 124 may be disposed separate from or internal to the deserializer 66 or the DQ receiver 62 of FIG. 3.

Distorted bit(s) may be transmitted to an amplifying device 126 from a channel 92 and transmitted from the amplifying device 126 to the DFE 124. The amplifying device 126 may be, for example, a variable gain amplifier. In some embodiments, the amplifying device may be a two stage amplifier with Continuous Time Linear Equalization (CTLE) in one of the stages of the amplifier. The distorted bit may be transmitted simultaneously with a DQ reference signal having a predetermined voltage (VRDQ) to the DFE 124. VRDQ may represent a threshold value (e.g., a voltage level) for determination if the transmitted bit received by the DQ connector 50 was a logical low (e.g., 0) or a logical high (e.g., 1). Thus, data bits may be received at a first input of the amplifying device 126 and a reference signal (e.g., VRDQ) may be received at a second input of the amplifying device 126.

In some embodiments, as noted above, the amplifying device 126 of FIG. 6 may represent a variable gain amplifier and continuous-time linear equalizer (CTLE). The output of the variable gain amplifier (e.g., Xs(t)) may be set to predetermined levels (e.g., settings), for example, values approximately between 0.5 times and 2.0 times the DC reference signal input to the variable gain amplifier or another level. The CTLE may operate to, for example, mitigate inter-symbol interference (ISI). More particularly, the CTLE generally operates to offset losses in the data stream (leading to a distorted bit) caused by, for example, the channel 92. The CTLE can generally operate to amplify higher frequency content of the data stream to equalize for these effects to the data stream (i.e., to boost higher frequency content, therefore making it effectively equivalent to amplitude at lower frequency components of the data stream). Accordingly, use of a CTLE in addition to a variable gain amplifier can operate to provide more reliable signals to the DFE 124 (e.g., increase the reliability of one or more of the distorted bit).

In some embodiments, the CTLE can be integrated into the amplifying device 126 (e.g., a portion of one of the stages of a variable gain amplifier). However, it should be noted that the CTLE circuitry can instead, for example, be disposed separately from (i.e., in series with) a variable gain amplifier used in the amplifying device. As illustrated, the amplifying device 126 receives data bits along channel 92, as well a reference signal, VRDQ (e.g., the DQ reference signal or “Vref”) and transmits an amplified result along path 128 to summers 130.

In the illustrated example, the DFE 124 may be operated to correct the distortion from the distorted bit (e.g., bit x) using the tap weighted with previous bit data. Data (e.g., logical 1 or logical 0) for a given bit may be passed through the amplifying device and may be transmitted through the path 128 to summers 130. The magnitudes and polarities of a weighted tap 86 (e.g., h1) may offset the total distortion caused by the x-1 bit via summers 130, which can operate as current summers that apply current to the distorted bit x to offset for distortion caused by the x-1 bit. The resultant signals output from the summers 130 are transmitted to a double tail latch 132 in an even bit portion of the DFE 124 (i.e., the upper illustrated portion of the DFE 124) and a double tail latch 134 in an odd bit portion of the DFE 124 (i.e., the lower illustrated portion of the DFE 94). The double tail latch 132 can include latch 115 and latch 117 while the double tail latch 134 can include latch 119 and latch 121. In operation latch 115 and latch 117 may operate in a manner similar to, for example, latch 100 and 122 and latch 119 and latch 121 may operate in a manner similar to, for example, latch 104 and 120. However, as illustrated, there is no selection circuit 112 or selection circuit 114 and, accordingly, no corresponding tu as propagation delay in the DFE 124. This can save approximately, for example, 60 psec, 70 70 psec, 80 psec, 90 psec, 100 psec or another amount of time with respect to the looptime margin of DFE 124 with respect to the looptime margin of DFE 94.

Path 123 operates as a feedback path transmitting a first weighted tap (h1) from an output of latch 115 to the summer 130 disposed in the odd bit portion of the DFE 124. Similarly, path 125 operates as a feedback path transmitting the first weighted tap (h1) from an output of latch 119 to the summer 130 disposed in the even bit portion of the DFE 124. Additionally, as illustrated, the timing of the output of latch 115 is controlled by the DQS signal while the timing of the output of latch 117 is controlled by the inverse of the DQS signal, DQSB. The timing of the output of latch 119 is controlled by DQSB and the timing of the output of latch 121 is controlled by DQS. The signal generated by latch 115 is based upon the output from the summer 130 disposed in the even bit portion of the DFE 124, as adjusted by a second weighted tap (h2) received from the output of latch 117 along path 127, a fourth weighted tap (h4) received from the output of latch 117 along path 127, and a third weighted tap (h3) received from the output of latch 121 along path 129. As noted above, the output of latch 115 is the resultant signal modified by the aforementioned weighted taps (h2, h3, and h4) and is transmitted along path 123, where it is used in the generation of the first weighted tap (h1) transmitted to the summer 130 disposed in the odd bit portion of the DFE 124. Additionally, the output of latch 115 is transmitted to latch 117 as an input signal to latch 117.

Latch 117 generates an output as controlled by the DQSB signal and this output is transmitted as the second weighted tap (h2) or the fourth weighted tap (h4) along path 127 to latch 115 or is transmitted as a third weighted tap (h3) to latch 119, depending on the state of operation of the double tail latch 132. For example, whether the output is transmitted as the second weighted tap (h2), the fourth weighted tap (h4) along path 127 to latch 115, or is transmitted as a third weighted tap (h3) to latch 119 depends on the phase of the DQSB signal (e.g., 0°, 90°, 180°, or) 270° that is being applied as a control signal for the latch 117. The output of latch 117 is also transmitted as the even data bits, which are output from the DFE 124 along path 108.

As additionally illustrated, the signal generated by latch 119 is based upon the output from the summer 130 disposed in the odd bit portion of the DFE 124, as adjusted by a second weighted tap (h2) received from the output of latch 121 along path 133, a fourth weighted tap (h4) received from the output of latch 121 along path 133, and a third weighted tap (h3) received from the output of latch 117 along path 131. As noted above, the output of latch 119 is the resultant signal modified by the aforementioned weighted taps (h2, h3, and h4) and is transmitted along path 125, where it is used in the generation of the first weighted tap (h1) transmitted to the summer 130 disposed in the even bit portion of the DFE 124. Additionally, the output of latch 119 is transmitted to latch 121 as an input signal to latch 117.

Latch 121 generates an output as controlled by the DQSB signal and this output is transmitted as the second weighted tap (h2) or the fourth weighted tap (h4) along path 133 to latch 119 or is transmitted as a third weighted tap (h3) along path 129 to latch 115, depending on the state of operation of the double tail latch 134. For example, whether the output is transmitted as the second weighted tap (h2), the fourth weighted tap (h4) along path 133 to latch 119, or is transmitted as a third weighted tap (h3) to latch 115 depends on the phase of the DQS signal (e.g., 0°, 90°, 180°, or) 270° that is being applied as a control signal for the latch 117. The output of latch 121 is also transmitted as the odd data bits, which are output from the DFE 124 along path 110.

Regarding the first weighted tap (h1) provided to each of the summers 130, it should be noted that the signal transmitted to the summers 130 may be selectively positive (i.e., +h1) or negative (i.e., −h1) as selectable by summers. That is, a first weighted tap can be provided as both a positive weighted tap value (e.g., +h1) and a negative weighted tap value (e.g., −h1). Additionally, in operation, the tap signal path of Tap1 (i.e., providing h1 to the summers 130) is t_{clk-to-Q}+ts, where t_{clk-to-Q} is the clock-to-Q delay of the respective latches 115, 117, 119, or 121 for a given (e.g., selected) path and ts is the settling time attributable to the summers 130. The tap signal path of Tap2 is t_{clk-to-Q}. In this manner, tu (i.e., the propagation delay of any selection circuit) is omitted from the DFE 124 and ts is the settling time attributable to the first stage of summers 96.

Because tu is omitted in the DFE 124, as operating speeds increase, the propagation delays described above with respect to DFE 94 can be avoided. For example, as operating speeds increase, the tap signal path of Tap2 (i.e., providing h2 to the first stage of the double tail latch 132 and the first stage of the double tail latch 134), for example, can arrive before data being provided from channel 92. Therefore, the weighting value associated with h2 will be correctly applied to the data (i.e., bit) being transmitted to the respective latch 115 and latch 119.

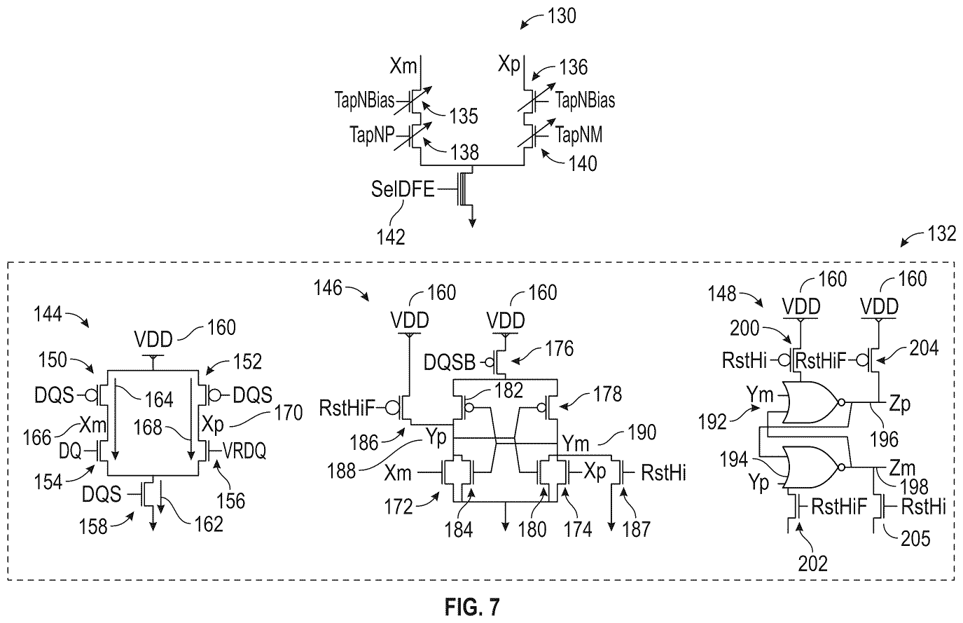

FIG. 7 illustrates an example of an embodiment of the summer 130 as well as an embodiment of the double tail latch 132 of a DFE, for example, DFE 124. In operation, the summer 130 receives an Xm signal and Xp signal from, for example, the amplifying device 126 as a portion of Xs (t). The Xm signal and the Xp signal can be used, for example, in tap polarity selection. Additionally, the summer 130 receives a TapNP and TapNM signal, which can correspond to the weighted tap value hn transmitted to the summer 130, for example, as a positive and a negative value. It should be noted that the “N” may be an integer representing the rank of the summer 130 in an N-tap DFE. For example in a four tap DFE, “N” can be 0-3. The summer 130 also receives a TapNBias signal at transistor 135 and transistor 136 that operates to control the range and step of the respective TapNP signal received at transistor 138 or TapNM signal received at transistor 140. Finally, the summer 130 receives a select signal along path 142 (SelDFE) that operates to select/output negative tap value for the hN tap value applied in the summer 130.

Xm and Xp, for example as an output from the summer 130, can be transmitted to a respective double tail latch, for example, double tail latch 132 of the DFE 124 when N=0. Thus, while double tail latch 132 is illustrated for purposes of discussion, the following discussion applies to additional double tail latches of the DFE 124. In some embodiments double tail latch 132 (as well as double tail latch 134 and any additional double tail latches utilized in a multi-tap DFE) can include multiple stages, for example, a first stage 144, a second stage 146, and a third stage 148. While three stages are illustrated, fewer or more stages can be utilized. The first stage 144 of the double tail latch 132 includes transistors (e.g., MOSFET transistors) 150, 152, 154, 156, and 158. In particular, the transistors 154 and 156 and the transistor 158 may be n-type transistors. Furthermore, the transistors 150 and 152 may be p-type transistors. A DQS input signal (e.g., UDQS_t/LDQS_t) may be connected to a gate of the transistors 150, 152, and 158 to clock the signals received by the transistors 150, 152, and 158 to sense and amplify one or more signals at the first stage 144. For instance, a DQ input signal (e.g., DQ<15:8>/DQ<7:0>) may be connected to a gate of the transistor 154. A voltage reference (VRDQ) may be connected to a gate of the transistor 156. Additionally, voltage source (VDD) 160 may be coupled to a source of the transistors 150 and 152. A total current (Iₜₒₜₐₗ) 162 flowing through the transistor 158 is equal to a first current (Iₘ) 164 flowing through the transistor 150 and the transistor 154 through an output node 166 coupled to Xm of the first stage 144 between them plus a second current (Iₚ) 168 flowing through the transistor 152 and the transistor 156 through an output node 170 (Xp) of the first stage 144. Xm at node 166 and Xp at node 170 may be output from the first stage 144 to the second stage 145 (sensing stage) after being developed by the DQS input signal.

For example, when the DQS input signal is low, the transistor 158 is off and the voltage of Xm at node 166 and Xp at node 170 is reset and pre-charged to VDD 160 through transistors 150 and 152. That is, the first stage 144 may be in a pre-charging phase when the DQS input signal is low.

Conversely, when the DQS input signal is high, the first stage 144 may be in a develop mode. In the develop mode, the transistors 150 and 152 are turned off and the transistor 158 is turned on. The transistors 154 and 156 may be turned on by the DQ input signal and the voltage reference VRDQ, respectively. The transistors 154 and 156 draw a differential current proportional to the potential difference between the voltage of the DQ input signal and the voltage reference. The differential current flow due to the discharge of voltage allows the differential voltage between Xm at node 166 and Xp at node 170 to increase (e.g., differential gain) relative to the differential voltage between the DQ input signal voltage and the voltage reference. That is, the differential voltage is amplified and discharges portions of the voltages at Xm at node 166 and Xp at node 170 to ground/VSS.

During the develop mode, a capacitive load at node 170 (Cload_{Xp}) may be discharged by the current Iₚ, and a capacitive load at node 166 (Cload_{Xm}) may be discharged by the current Iₘ. The capacitive load Cload_{Xm} may be due to parasitic capacitance across terminals of the transistors 150 and 152 along with parasitic capacitances in the second stage 146 (coupled to node 166). Similarly, the capacitive load Cload_{Xp} may be due to parasitic capacitance across terminals of the transistors 152 and 156 along with parasitic capacitances in the second stage 146 coupled to node 170. Specifically, the voltage of Xm at node 166 may be defined using the following equation:

$${V}_{Xm} = \frac{{I}_{m} * UI}{{Cload}_{Xm}} , \qquad ( Equation 1 )$$

where Vₓₘ is the voltage of Xm at node 166 and UI is unit interval based on an operating frequency. Similarly, the voltage of Xp at node 170 may be defined using the following equation:

$${V}_{Xp} = \frac{{I}_{p} * UI}{{Cload}_{Xp}} , \qquad ( Equation 2 )$$

where Vₓₚ is the voltage of Xp at node 170. Thus, the voltage difference (Vdiff) between Vₓₚ and Vₓₘ may be written as the following equation:

$$V diff = {V}_{Xp} - {V}_{Xm} = \frac{UI * ( {I}_{p} - {I}_{m} )}{N} , \qquad ( Equation 3 )$$

where N is equal to the Cload_{Xp} and the Cload_{Xm}. The Vdiff may be inversely proportional to a propagation delay of the DQ input signal through the double tail latch 132.

FIG. 7 additionally shows a circuit diagram of the second stage 146 of the double tail latch 132. As illustrated, the second stage 146 includes transistors (e.g., MOSFET transistors) 174, 176, 178, 180, 182, 184, 186, and 187. In particular, transistors 172, 174, 180, 184, and 187 may be n-type transistors. Furthermore, transistors 176, 178, 182, and 186 may be p-type transistors. A DQSB may be an inverted data strobe signal (e.g., UDQS_c/LDQS_c) that is complimentary to the DQS input signal. DQSB may be connected to a gate of the transistor 176. Additionally, VDD 160 may be coupled to a source of the transistor 176.

As Xm and Xp discharge due to the DQS input signal transitioning high, the transistors 172 and 174 are switched off due to their respective gates being coupled to Xm and Xp. This causes output node 188 (i.e., Yp) and output node 190 (i.e., Ym) to be precharged due to DQSB being low when the DQS input signal is high. As Xm and Xp charge due to the DQS input signal transitioning low, the transistors 172 and 174 are switched on while the transistor 176 is switched off. Due to the differences in Xm and Xp, the discharge of Yp at node 188 and Ym at node 190 may occur at different times/rates. Using this difference, the differential voltage is built up through the transistors 172 and 174 and passed to the transistors 178, 180, 182, and 184.

Additionally, as noted above, the second stage 146 further includes transistor 186 and transistor 187. Transistor 186 may operate to reset the second stage 146 based on the value of received signal RstHiF received at the gate of transistor 186. Likewise, transistor 187 may operate to reset the second stage 146 based on the value of received signal RstHi (e.g., the inverse of RstHiF) received at the gate of transistor 187. For example, when RstHiF is high and RstHi is low, transistor 186 does not affect the voltage at node 188 and transistor 186 does not affect the voltage at node 190 (i.e., Yp and Ym are unaffected). However, when RstHiF is low and RstHi is high, transistor 186 allows for the connection of VDD 160 to node 188 and transistor 187 allows for the connection of node 190 to ground/VSS, causing changes in the voltages of Yp and Ym. In this manner, Yp and Ym can be controlled and reset based on the value of RstHiF.

FIG. 7 additionally shows a circuit diagram of the third stage 148 of the double tail latch 132. As illustrated, the third stage 148 includes a SR flip-flop. The SR flip-flop may be implemented using NOR gates 192 and 194. The NOR gate 192 receives Ym from node 190 and outputs Zp from node 196. Likewise, the NOR gate 194 receives Yp from node 188 and outputs Zm from node 198. In this manner, Zp and Zm represent the resultant output signals generated by the double tail latch 132 for a given data input to the DFE 124.

The third stage 148 further includes transistors (e.g., MOSFET transistors) 200, 202, 204, and 205. In particular, transistors 202 and 205 may be n-type transistors while transistors 200 and 204 may be p-type transistors. Transistors 200 and 204 can be coupled to the NOR gate 192 and the NOR gate 194, respectively. Similarly, transistors 202 and 205 can be coupled to node 196 and node 198, respectively. Each of transistors 200 and 205 can receive signal RstHi at their respective gate and transistors 202 and 204 can receive signal RstHiF (the inverse of signal RstHi) at their respective gate.

In operation, transistors 200, 202, 204, and 205 operate to reset the third stage 148 based on the value of received signals RstHi and RstHiF received at the respective gates of transistors 200, 202, 204, and 205. For example, when RstHiF is high and RstHi is low, transistors 204 and 205 do not affect either of node 196 or node 198 (i.e., Zp and Zm are unaffected). However, when RstHiF is low and RstHi is high, transistors 204 and 205 allow for the connection of VDD 160 to node 196 and the connection of ground/VSS to node 198, causing changes in the voltages of Zp and Zm. In this manner, Zp and Zm can be controlled and reset based on the value of RstHiF and RstHi.

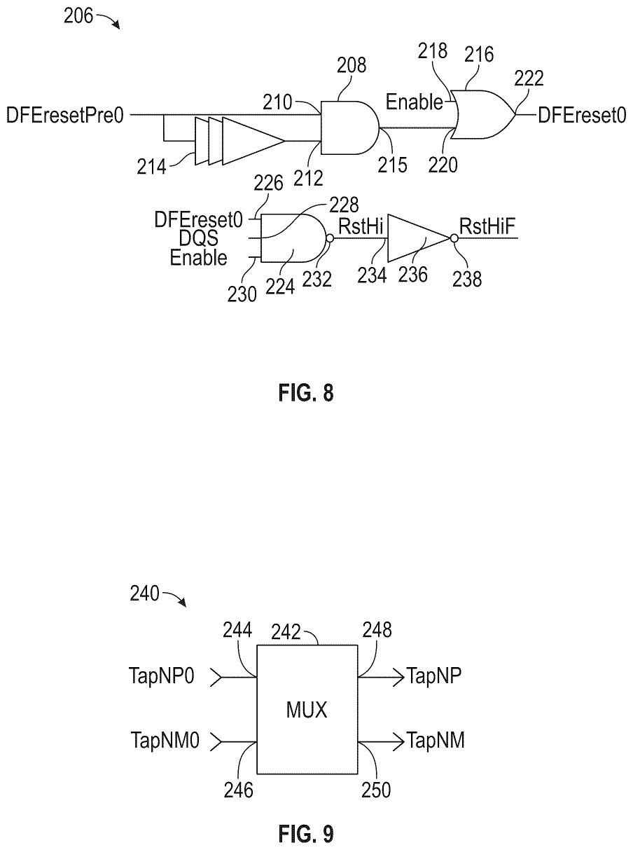

As noted above, resets of the double tail latch 132 and, thus, the DFE 124 can be accomplished using the RstHiF signal (and the RstHi signal). Reset of the DFE 124 may be useful, for example, between write operations to initialize the DFE 124 for a new write operation. FIG. 8 illustrates an embodiment of DFE reset circuitry 206 that operates to generate the RstHiF and RstHi signals used in resetting the DFE 124, in accordance with the circuitry of FIG. 7. In some embodiments, a single DFE reset circuitry 206 can be implemented for an N-tap DFE. In other embodiments, a respective DFE reset circuitry 206 can be implemented for each tap of an N-tap DFE.

As illustrated, the DFE reset circuitry 206 includes an AND gate 208 that receives a DFEresetPre0 signal at input 210 (e.g., an input pin). The DFEresetPre0 signal may be an externally generated signal (e.g., externally generated from the DFE 124) transmitted to the DFE reset circuitry 206 as a control signal to institute reset of the DFE 124. AND gate 208 also includes input 212 (e.g., an input pin) that receives a buffered version of the DFEresetPre0 signal. The buffering of the DFEresetPre0 signal can be accomplished via one or more buffer circuits 214. The amount of buffering applied to the DFEresetPre0 signal can be altered by increasing or decreasing the number of buffer circuits 214 utilized.

In operation, when each of the DFEresetPre0 signal and the buffered DFEresetPre0 signal are high (e.g., “1”) at input 210 and input 212, AND gate 208 issues a high signal from output 215 (e.g., an output pin) of AND gate 208. Likewise if one or both of the DFEresetPre0 signal and the buffered DFEresetPre0 signal are low (e.g., “0”) at input 210 and input 212, AND gate 208 issues a low signal from output 215 of AND gate 208. As illustrated, the DFE reset circuitry 206 also includes an OR gate 216.

OR gate 216 of the DFE reset circuitry 206 includes input 218 (e.g., an input pin), input 220 (e.g., an input pin), and output 222 (e.g., an output pin). Input 218 can receive an enable signal. The enable signal may be an externally generated signal (e.g., externally generated from the DFE 124) transmitted to the DFE reset circuitry 206 as a control signal. In some embodiments, for example, the enable signal is high whenever the DFE 124 is activated, else the enable signal is low. In other embodiments, for example, the enable signal may be set to high when a reset operation of the DFE 124 is to be undertaken.

Input 220 of OR gate 216 can be coupled to the output 215 of the AND gate 208 to receive the signal generated by the AND gate 208. In operation, when either (or both) of the signals at input 218 or input 220 are high, the OR gate 216 transmits a DFEreset0 signal from output 222 as having a high value (e.g., “1”). Likewise, when both of the signals at input 218 and input 220 are low, the OR gate 216 transmits a DFEreset0 signal from output 222 as having a high value (e.g., “1”). As illustrated, the DFEreset0 signal transmitted from the OR gate 216 can be transmitted to NAND gate 224. For example, the DFEreset0 signal transmitted from the OR gate 216 can be transmitted to input 226 (e.g., input pin) of the NAND gate 224. The NAND gate 224 can also include input 226 and 228. Input 228 can receive a DQS signal and input 230 can receive an enable signal, which can be the same or a different enable signal from that received at input 218 of the NOR gate 216.

NAND gate 224 also includes an output 232 (e.g., an output pin) that transmits an RstHi signal generated by the NAND gate 224. For example, while in operation, if any (or all) of the DFEreset0 signal at input 226, the DQS signal at input 228 and the enable signal at input 230 are low, the NAND gate 224 generates a high signal as the RstHi signal. Similarly, if all of the DFEreset0 signal at input 226, the DQS signal at input 228 and the enable signal at input 230 are high, the NAND gate 224 generates a low signal as the RstHi signal. The generated RstHi signal can be coupled from the output 232 of the NAND gate 224 to the transistor 187, the transistor 200, and the transistor 205 for use in a reset operation of the DFE 124, as described above with respect to FIG. 7.

As additionally, illustrated in FIG. 8, the output 232 of the NAND gate 224 is coupled to an input 234 (e.g., an input pin) of inverter 236. Inverter 236 also includes an output 238 that transmits a generated RstHiF signal (i.e., the inverse of the RstHi signal). Output 238 of the inverter 236 can be coupled to the transistor 186, the transistor 202, and the transistor 204 for use in a reset operation of the DFE 124, as described above with respect to FIG. 7.

FIG. 9 illustrates tap signal control logic 240 that can be used in conjunction with the DFE reset circuitry 206 of FIG. 8. In some embodiments, a single tap signal control logic 240 can be implemented for an N-tap DFE. In other embodiments, a respective tap signal control logic 240 can be implemented for each tap of an N-tap DFE. As illustrated, the tap signal control logic 240 can include a multiplexer 242 having input 244 (e.g., an input pin), input 246, output 248 (e.g., an output pin), and output 250. The multiplexer 242 receives a TapNP0 signal at input 244 (e.g., a tap signal from a zero phase of the TapNP signal) and receives a TapNM0 signal at input 244 (e.g., a tap signal from a zero phase of the TapNM signal). In operation, the multiplexer 242 selectively transmits the signals received at input 244 and 246 from output 248 and output 250 as a TapNP signal and a TapNM signal. Output 248 is coupled to transistor 138 and output 250 is coupled to transistor 140 of summer 130 and is utilized in the generation of Xm and Xp in the manner described above with respect to FIG. 7.

The tap signal control logic 240 of FIG. 9 and the DFE reset circuitry 206 of FIG. 8 are each used to generate control signals to affect operation of the DFE 124, by altering Xm and Xp or by resetting the DFE 124, respectively. It should be noted that the DFE reset circuitry 206 only includes asynchronous circuits. That is, no clocked circuits are used in the generation of the RstHi signal and the RstHiF signal in conjunction with the DFE reset circuitry 206. In some embodiments, this can impact the reset operation of the DFE 124. For example, environmental and/or manufacturing differences can impact the operation of the DFE reset circuitry 206 (i.e., operation the asynchronous circuits therein), particularly as signal speeds of the memory device 10 increase (for example, at or above 9 Gbps). For example, process, voltage, and temperature (PVT) changes can affect the operation of the DFE reset circuitry 206, causing delays in transmission of the RstHi signal and the RstHiF signal. These delays can cause, for example, a DFE reset operation to extend into a period of time in which a memory operation (e.g., a memory write) is being executed by the memory device 10, causing errors in the memory operation. Furthermore, the delays in the transmission of the RstHi signal and the RstHiF signal are not synchronized with other delays being experienced in the memory device 10 due, at least in part, to the use of only asynchronous circuits in the DFE reset circuitry 206.

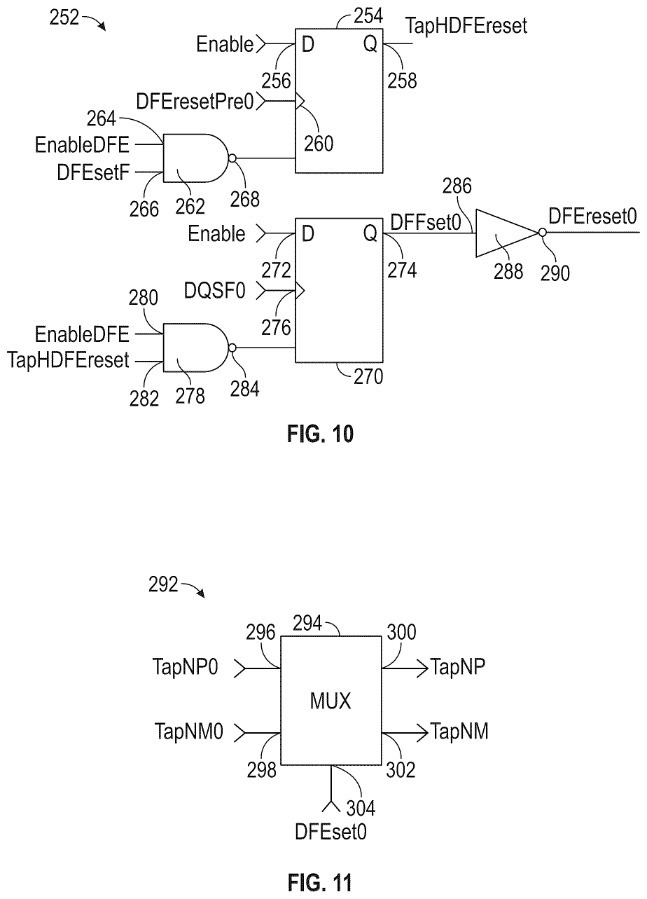

FIG. 10 illustrates an embodiment of DFE reset circuitry 252 that operates utilizing synchronous circuits (e.g., circuits in which the output is triggered by a clock signal or another signal at a clock input). As illustrated, the DFE reset circuitry 252 includes a D-type flip-flop 254 having an input 256 (e.g., an input pin) and an output 258 (e.g., an output pin). The input 256 receives an enable signal and transmits that enable signal as a TapHDFEreset signal from output 258 based on the DFEresetPre0 signal received at clock input 260 of the D-type flip-flop 254. In this manner, the DFE reset circuitry 252 utilizes the same DFEresetPre0 as employed in conjunction with the DFE reset circuitry 206. That is, the DFE reset circuitry 252 can be substituted for the DFE reset circuitry 206 without changing the external signals (e.g., externally generated from the DFE 124) that are transmitted to the DFE reset circuitry 206 as a control signal to institute a reset of the DFE 124.

In some embodiments, a control or enable signal may also be generated and transmitted to the D-type flip-flop 254. For example, NAND gate 262 can include an input 264 that receives an EnableDFE signal and input 266 that can receive a DFEsetF signal (which may be an inverse of a DFEset signal generated by the DFE reset circuitry 252). The generated signal from the NAND gate 262 based upon the signals received at input 264 and 266 is transmitted from output 268 to the D-type flip-flop 254, for example, as an enable or other control signal.

The DFE reset circuitry 252 further includes a D-type flip-flop 270 having an input 272 (e.g., an input pin) and an output 274 (e.g., an output pin). The input 272 receives an enable signal (e.g., the same enable signal as received at input 256 of D-type flip-flop 254) and transmits that enable signal as a DFEset0 signal (e.g., a DFEset signal corresponding to a zero phase, whereby the phase alters during operation from zero to 180 to 270 and back to zero) based on a DQSF0 (i.e., a phased DSQ signal) received at clock input 276 of the D-type flip-flop 270.

In some embodiments, a control or enable signal may also be generated and transmitted to the D-type flip-flop 270. For example, NAND gate 278 can include an input 280 that receives the EnableDFE signal and input 282 that can receives the TapHDFEreset signal from output 258 of the D-type flip-flop 254. The generated signal from the NAND gate 278 based upon the signals received at input 264 and 266 is transmitted from output 284 to the D-type flip-flop 270, for example, as an enable or other control signal. In this manner, the output of the D-type flip-flop 254, generated based on the DFEresetPre0 signal, controls functioning of the D-type flip-flop 270 and, accordingly, the generated DFEset0 signal transmitted from output 274 of the D-type flip-flop 270. In some embodiments, the output 274 can further be coupled to an input 286 (e.g., an input pin) of inverter 288. Inverter 288 also includes an output 290 that transmits a generated DFEreset0 signal as the inverse of the DFEset0 signal.

FIG. 11 illustrates tap signal control logic 292 that can be used in conjunction with the DFE reset circuitry 252 of FIG. 10. In some embodiments, a single tap signal control logic 292 can be implemented for an N-tap DFE. In other embodiments, a respective tap signal control logic 292 can be implemented for each tap of an N-tap DFE. As illustrated, the tap signal control logic 292 can include a multiplexer 294 having input 296 (e.g., an input pin), input 298, output 300 (e.g., an output pin), and output 302. The multiplexer 294 receives the TapNP0 signal at input 296 (e.g., a tap signal from a zero phase of the TapNP signal) and receives a TapNM0 signal at input 298 (e.g., a tap signal from a zero phase of the TapNM signal). In operation, the multiplexer 294 selectively transmits the signals received at input 296 and 298 from output 300 and output 302 as a TapNP signal and a TapNM signal.

The operation of the multiplexer 294 can be controlled via the signal received at control input 304 of the multiplexer 294. Control input 304 can be coupled to output 274 of the D-type flip-flop 270. In this manner, the multiplexer 294 differs from the multiplexer 242 of FIG. 9 in that the multiplexer 242 of FIG. 9 does not receive its control signal (i.e., selection signal) from the DFE reset circuitry 206 while the multiplexer 294 does receive its control signal from the DFE reset circuitry 252. When a reset operation is to occur, the value of the a DFEset0 changes, causing the polarity of the TapNP signal transmitted from output 300 of the multiplexer 294 and the polarity of the TapNM signal transmitted from output 302 to be switched through, for example, transmission of the TapNP0 signal from input 296 to output 302 and transmission of the TapNM0 signal from input 298 to output 302). Through reversal of the polarity of the TapNP signal and the TapNM signal, the reset operation of the DFE 124 can be executed.

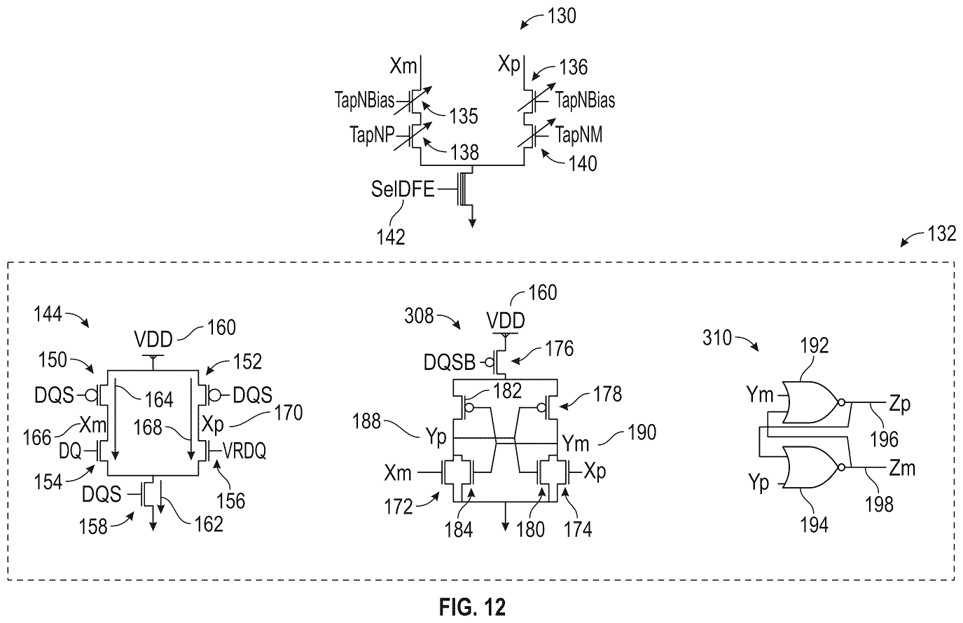

FIG. 12 illustrates summer 130 as well as an embodiment of the double tail latch 132 of a DFE, for example, DFE 124 that can be used in conjunction with the DFE reset circuitry 252 of FIG. 10 and the tap signal control logic 292 of FIG. 11. The summer 130 of FIG. 12 is identical to the summer 130 of FIG. 7; however, summer 130 of FIG. 12 receives the TapNP signal at transistor 138 and the TapNM signal transistor 140 from the tap signal control logic 292. Thus, when a reset operation is undertaken, switching of the polarities of the TapNP signal and the TapNM signal result in alteration of the Xm and Xp signals of the summer 130.

The Xm and Xp signals are transmitted to a respective double tail latch, for example, double tail latch 132 of the DFE 124 when N=0. Thus, while double tail latch 132 is illustrated for purposes of discussion, the following discussion applies to additional double tail latches of the DFE 124. In some embodiments double tail latch 132 (as well as double tail latch 134 and any additional double tail latches utilized in a multi-tap DFE) can include multiple stages, for example, first stage 144, a second stage 308, and a third stage 310. While three stages are illustrated, fewer or more stages can be utilized. The first stage 144 of the double tail latch 132 in FIG. 12 is identical to the first stage 144 of FIG. 7. However, as it receives Xm and Xp signals from the summer 130 of FIG. 12, the first stage 144 of FIG. 12 the values of the Xm and Xp signals received are altered when a reset operation is undertaken.

FIG. 12 additionally shows a circuit diagram of the second stage 308 of the double tail latch 132. As illustrated, the second stage 308 is identical to the second stage 146 of FIG. 7 with transistor 186 and transistor 187 having been removed. In this manner, second stage 308 of FIG. 12 differs from the second stage 146 of FIG. 7 in that it does not include reset latches (i.e., transistor 186 and transistor 187). Similarly, FIG. 12 illustrates a circuit diagram of the third stage 310 of the double tail latch 132. As illustrated, the third stage 310 is identical to the third stage 148 of FIG. 7 with transistors 200, 202, 204, and 205 having been removed. In this manner, third stage 310 of FIG. 12 differs from the third stage 148 of FIG. 7 in that it does not include reset latches (i.e., transistors 200, 202, 204, and 205). Thus, FIG. 12 illustrates a double tail latch 132 that can be utilized in a reset operation of the DFE 124 without use of any reset latches directly receiving a reset signal (e.g., the RstHi signal and/or the RstHiF signal).

Thus, the double tail latch 132 of FIG. 12 can be simpler and smaller in size than the double tail latch 132 of FIG. 7, while still allowing for reset of the DFE 124 to be performed. Through control and alteration of the Xm and Xp signals generated in the summer 130, subsequent control of the Yp, Ym, Zp, and Zm signals in the second stage 308 and the third stage 310, respectively, can be affected. Moreover, since the DRE reset signals are generated in the DFE reset circuitry 252 utilizing synchronous circuitry, environmental factors (e.g., PVT) affecting the memory device 10 in generation of, for example, the DFEresetPre0 signal and the DSQF0 are accounted for, based on their use as clocking signals in generating the DFEset0 utilized to implement the reset operation of the DFE 124. In this manner, there is a reduced chance for timing mismatches between a reset operation and a memory operation which, in turn, allows for reset operations to be performed with faster data rates (i.e., signal speeds of the memory device 10, for example, at or above 9 Gbps). Moreover, removal of the reset latches in the second stage 308 and the third stage 310 (i.e., transistors 186, 187, 200, 202, 204, and 205) can allow for increased memory margins due to removal of the loading associated with the reset latches. Furthermore, only swapping of the DFE reset circuitry 206 of FIG. 7 with the DFE reset circuitry 252 of FIG. 10 allows for the double tail latch 132 of FIG. 12 to be implements with its associated operational gains.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A device, comprising:
decision feedback equalizer (DFE) reset circuitry comprising synchronous circuitry, wherein the DFE reset circuitry is configured to:
receive a DFE reset signal to initiate a reset operation of a DFE;
generate a first control signal based upon the DFE reset signal; and
transmit the first control signal to alter a data signal generated in a summer circuit of the DFE to affect the reset operation of the DFE.

2. The device of claim 1, wherein the DFE reset circuitry comprises a first flip-flop comprising a first input configured to receive the DFE reset signal.

3. The device of claim 2, wherein the first input comprises a first clock input of the first flip-flop.

4. The device of claim 3, wherein the first flip-flop comprises a first output configured to transmit a second control signal based upon the DFE reset signal.

5. The device of claim 4, comprising a second flip-flop comprising a second clock input configured to receive a clocking signal generated based on at least one data strobe signal of a memory device comprising the DFE.

6. The device of claim 5, wherein the second flip-flop comprises an enable input configured to receive an activation signal to activate the second flip-flop.

7. The device of claim 6, comprising a logic element coupled to the first output and the enable input, wherein the logic element is configured to generate the activation signal based at least in part on the second control signal.

8. The device of claim 5, wherein the second flip-flop comprises a second output configured to transmit the first control signal.

9. A device, comprising:
tap signal control logic comprising:
a first output configured to be coupled to a summer circuit of a decision feedback equalizer (DFE) in a memory device;
a second output configured to be coupled to the summer circuit of the DFE; and
a control input configured to be coupled to DFE reset circuitry to receive a control signal to select a first signal to be transmitted from the first output and a second signal to be transmitted from the second output in conjunction with a reset operation of the DFE.

10. The device of claim 9, wherein the first output is configured to be coupled to a first gate of a first transistor of the summer circuit.

11. The device of claim 10, wherein the second output is configured to be coupled to a second gate of a second transistor of the summer circuit.

12. The device of claim 11, wherein the first output is configured to transmit a TapNP signal as the first signal to the first gate, wherein the TapNP signal corresponds to a weighted tap value transmitted to the summer circuit as having one of a positive value and a negative value.

13. The device of claim 12, wherein the second output is configured to transmit a TapNM signal as the second signal to the second gate, wherein the TapNM signal corresponds to the weighted tap value transmitted to the summer circuit as having another of the positive value and the negative value.

14. The device of claim 13, wherein the tap signal control logic is configured to reverse a respective polarity of each of the TapNP signal and the TapNM signal in conjunction with the reset operation of the DFE based upon the control signal.

15. A device, comprising:
a decision feedback equalizer (DFE) circuit, comprising:
a summer circuit configured to receive a data signal of a series of data signals; and
a double tail latch circuit coupled to the summer circuit to receive a first output signal generated by the summer circuit, wherein the double tail latch circuit comprises a first stage, a second stage coupled to the first stage, and a third stage coupled to the second stage, wherein the double tail latch is utilized in a reset operation of the DFE circuit without any reset latches present in any of the first stage, the second stage and the third stage and without any of the first stage, the second stage and the third stage of the double tail latch directly receiving a reset signal generated based upon a control signal generated externally from the DFE to initiate reset of the DFE.

16. The device of claim 15, wherein the summer circuit is configured to generate the first output signal based upon the data signal.

17. The device of claim 16, wherein the summer circuit comprises a first transistor comprising a first gate, wherein the summer circuit is configured to receive a TapNP signal at the first gate, wherein the TapNP signal corresponds to a weighted tap value transmitted to the summer circuit as having one of a positive value and a negative value.

18. The device of claim 17, wherein the summer circuit comprises a second transistor comprising a second gate, wherein the second transistor is disposed in parallel with the first transistor, wherein the summer circuit is configured to receive a TapNM signal at the second gate, wherein the TapNM signal corresponds to the weighted tap value transmitted to the summer circuit as having another of the positive value and the negative value.

19. The device of claim 18, comprising tap signal control logic coupled to the summer circuit, wherein the tap signal control logic is configured to reverse a respective polarity of each of the TapNP signal and the TapNM signal in conjunction with the reset of the DFE based upon a second control signal received at the tap signal control logic.

20. The device of claim 19, comprising DFE reset circuitry coupled to the tap signal control logic, wherein the DFE reset circuitry is configured to receive the reset signal and generate the second control signal based upon the reset signal.
